(19) United States
(12) Patent Application Publication
(10) Pub. No.: US 2010/0135881 A1
(43) Pub. Date: Jun. 3, 2010

(54) PROCESS FOR SIMULTANEOUS REMOVAL OF CARBON DIOXIDE AND SULFUR OXIDES FROM FLUE GAS

(76) Inventors: Lubo Zhou, Inverness, IL (US); Dennis J. Bellville, Deer Park, IL (US); Edward P. Zbacnik, Fox River Grove, IL (US)

Correspondence Address: HONEYWELL/UOP;PATENT SERVICES, 101 COLUMBIA DRIVE, P O BOX 2245 MAIL STOP AB/2B, MORRISTOWN, NJ, 07962, US

(21) Appl. No.: 12/510,735

(22) Filed: Jul. 28, 2009

(51) Int. Cl. B01D 53/50; B01D 53/62

(52) U.S. Cl. 423/230

(57) ABSTRACT

A process is provided for the simultaneous removal of carbon dioxide and sulfur oxides from a flue gas stream by a potassium carbonate solvent. As a part of the regeneration of the contaminated stream, a portion of that stream is removed and cooled to allow for filtration of potassium sulfate, the reaction product of the solvent and the sulfur oxides.

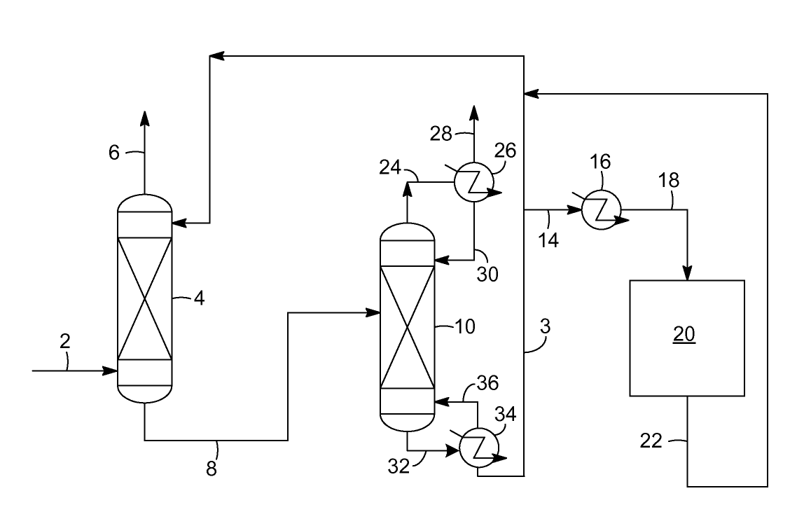

### BACKGROUND OF THE INVENTION

The invention relates to a novel gas treating process suitable for treating flue gas streams that are produced in various industrial processes such as in coal fired power plants. The invention more specifically relates to a process for the simultaneous removal of sulfur oxides and carbon dioxide from a gas stream using a potassium carbonate absorbent. Even more specifically, the process involves the removal of potassium sulfate to avoid its interference with the absorption of carbon dioxide.

Flue gas from power plants contains pollutants, including sulfur oxides (including SO₂ and SO₃, collectively SOₓ), NOₓ and CO₂. SOₓ is the source of acid rain, and is required by environmental laws and regulations to be captured from the flue gas. The standard commercial technology for SOₓ removal is to inject lime stone in a flue gas desulfurization unit, which is called the “FGD.” In general, the FGD unit is very large and requires large capital investments. Hence, there are still many power plants in the United States and elsewhere that have not yet installed an FGD unit. Recent years, CO₂ as a green house gas has captured people's attention. Currently, the biggest source of CO₂ release is the flue gas from power plants. In order to reduce green house gas release, people have proposed technologies for CO₂ capture and sequestration. Due to the need to remove both CO₂ and SOₓ, it is desirable to have improved technologies to remove both gases. The present invention presents a process technology that simultaneously removes both SOₓ and CO₂ from flue gas.

Carbon dioxide has been commonly identified as one of the greenhouse gases, i.e., it is one of those gases considered to be a major threat to the environment, due to the greenhouse effect attributable thereto.

In the prior art there are many methods for separating carbon dioxide from gases containing the same. Thus, the following prior art processes have been proposed: a) Mono- and Di-ethanolamine Processes; b) Hot Carbonate Process; c) Sulfinol Process; d) Selexol Process; and e) Modified Selexol-ammonia process.

Thus, despite the existence of these various processes, improved processes are still required. However, despite the enormous financial incentive, the prior art has far to go to provide efficient solutions for providing a non-hazardous CO₂ sink applicable to such situations.

Similarly, sulfur and nitrogen in oil or coal result in sulfur dioxide (SO₂) and sulfur trioxide (SO₃) and various nitrogen oxides (NOₓ) in addition to carbon dioxide (CO₂) in the flue gas. These oxides are hazardous and are the main contributors to the deteriorating quality of ambient air.

Analysis of numerous epidemiological studies clearly indicates an association between air pollution as measured by sulfur dioxide concentrations and health effects of varying severities, particularly among the most susceptible elements of the population. In addition, sulfur dioxide leads to acid rain, which causes extensive damage to plants and is corrosive to many types of materials.

It will therefore be realized that reduction in the emissions of SO₂, NOₓ, and CO₂ has become increasingly more important, because of the deteriorating ambient air qualities in many industrial countries; the heavy fines being levied for failure to comply with the new standards which have been set; the increasing concern over acid rain; the tightening of emission standards, and the push for the use of more coal to satisfy the energy needs, all of which point to an urgent need for more efficient and more economic processes.

In light of the above, there have been suggested four major avenues for reduction of SOₓ emission to the atmosphere as a result of coal consumption: a) reduction of coal consumption; b) utilization of naturally occurring low sulfur coal; c) physical coal cleaning utilizing the differences in physical properties between inorganic pyritic sulfur and other coal constituents; and d) flue gas treatment to remove sulfur dioxide from combustion gases. Since option (a) above is not truly practical, and options (b) and (c) are of limited applicability, the major research effort has been directed to option (d).

A review of the literature, however, has indicated that many of the processes suggested for removing sulfur dioxide from combustion gases involve the use of lime or limestone as a reactant. A major problem with the use of lime or limestone for reducing atmospheric pollution caused by SO₂ is that while lime can provide a sink for large amounts of SO₂, it is produced from CaCO₃ in a process which evolves CO₂ and thus the preparation thereof is in itself a cause for atmospheric pollution caused by CO₂. In addition, the preparation of lime consumes energy, which process by itself adds to the pollution. Another approach to dealing with SO₂ emissions involves reversible absorption followed by desorption and then conversion to sulfuric acid or sulfur. This conversion, however, requires the use of reagents and catalysts, and therefore is not preferred, due to the expense thereof.

Aqueous carbonate solutions are widely used to remove the common acidic gases, hydrogen sulfide and carbon dioxide, from gas streams. This process is described in some detail in U.S. Pat. No. 2,886,405 and U.S. Pat. No. 4,160,810. A commercial form of this process is the widely used Benfield process. This process is described in these two U.S. patents and in a brief summary presented at page 93 of the April 1982 issue of HYDROCARBON PROCESSING. In processes of this type, the feed gas stream enters the lower portion of an absorber and passes upward countercurrent to a lean aqueous carbonate solution which enters an upper portion of the absorber. This produces a purified product gas stream and a rich aqueous carbonate solution which contains the acid gas removed from the feed gas stream. The rich solution is then passed into a regenerator commonly referred to as a stripping column. A lower pressure and/or higher temperature maintained within the stripping column results in the release of the absorbed acid gases which are removed overhead from the stripping column. This regeneration procedure also produces a stream of lean carbonate solution which is recycled to the top of the absorber.

It has remained difficult to remove carbon dioxide, sulfur oxides and nitrous oxides due to the difficulty in removing the sulfur from the potassium carbonate absorbent. Now a process and system have been developed that successfully reduces the concentration of sulfur in the process stream by precipitating out a large portion of the potassium sulfate that is the reaction product of sulfur oxides in the flue gas stream and the potassium carbonate absorbent.

### SUMMARY OF THE INVENTION

The present invention provides a method of simultaneously reducing carbon dioxide and sulfur oxide emissions produced by the combustion of carbon-containing matter, the method comprising sending flue gas to an absorber unit to be contacted with a potassium carbonate solution to remove CO₂ and SOₓ to produce a treated gas and a rich stream of potassium carbonate solvent containing CO₂, SOₓ, KHCO₃ produced by reaction of said potassium carbonate solution and CO₂, and K₂SO₄ produced by reaction of said potassium carbonate solution and SOₓ; sending the rich stream to a stripper to remove CO₂ from the rich stream of potassium carbonate solvent and to produce a partially rich solvent stream containing K₂SO₄; removing a portion of the partially rich solvent stream; and then removing K₂SO₄ from the rich solvent stream by cooling it to a temperature at which K₂SO₄ will precipitate out to produce a lean solvent stream; and returning the lean solvent stream to the potassium carbonate solution. The removal of the K₂SO₄ allows for the process to function without the K₂SO₄ interfering with the absorption of carbon dioxide.

### BRIEF DESCRIPTION OF THE DRAWING

The FIGURE is a simplified process flow diagram illustrating the process for simultaneous removal of carbon dioxide and sulfur oxides from a flue gas stream. This process flow diagram has been simplified in that it does not show the many pieces of mechanical apparatus normally found on such a process including pumps, pressure, temperature and flow rate monitoring and control systems, vessel internals, etc.

### DETAILED DESCRIPTION OF THE INVENTION

Combustion of carbon-containing matter such as fossil fuels or waste produces gaseous emissions of carbon dioxide and sulfur oxides. It is recognized that CO₂ is a “greenhouse” gas whose concentration in the atmosphere is increasing, which is considered to contribute to global warming. Current and proposed regulations in the United States and elsewhere in the world are providing an incentive to develop and implement technologies to reduce the amount of carbon dioxide sent into the atmosphere. The carbon dioxide may be injected deep underground in some instances. The recovered carbon dioxide can also be used in enhanced oil recovery techniques which are being employed on a greater scale due to the elevated price of petroleum products that provides the incentive for increased production of petroleum reserves that are more difficult or costly to access. Carbon dioxide is also used in various industries such as in the production of carbonated beverages and it can be used as a refrigerant.

The established need for processes for the removal of carbon dioxide from gas streams has prompted the development of a number of commercially practiced gas treating processes. The present invention involves an improvement in a process in which a feed gas (flue gas here) goes through an absorber where CO₂ is captured by a solvent comprising K₂CO₃ in a water solution. The primary reaction that takes place in the absorber is represented by the equation:

CO₂+H₂O+K₂CO₃→2KHCO₃

While the CO₂ reacts with K₂CO₃ to generate KHCO₃, this reaction is reversible at higher temperature. The rich solvent after reacting with CO₂ is sent to a stripper for regeneration in which KHCO₃ is converted back to CO₂ and K₂CO₃ through the reverse reaction as:

2KHCO₃→CO₂+H₂O+K₂CO₃

In the feed flue gas, CO₂ is mixed with other gases such as nitrogen. Since nitrogen will not react with K₂CO₃, the rich solvent from the absorber bottom contains very little nitrogen since it has no reaction with K₂CO₃ and low solubility in the solvent. At the stripper column top, the regenerated CO₂ is present in a very high concentration (>99%), and can be readily compressed for sequestration.

Sulfur oxides often exist in the flue gas. SO₂ (a majority of SOₓ) can react with K₂CO₃ through the following reaction:

$${SO}_{2} + \frac{1}{2} {O}_{2} + {K}_{2} {CO}_{3} \to {K}_{2} {SO}_{4} + {CO}_{2}$$

A small amount of SO₃ included in the sulfur oxides can also convert to K₂SO₄ by the following reaction:

SO₃+K₂CO₃→K₂SO₄+CO₂.

The above equations under Benfield process operating conditions are not reversible. Hence, the stripper regeneration can not remove K₂SO₄, which will increase in concentration in the K₂CO₃ solution if it can not be removed by another way. Our pilot plant tests showed that when K₂SO₄ concentration in the K₂CO₃ solvent is low (lower than 2%), the effect of K₂SO4 on CO₂ capture by K₂CO₃ is very small. Conversely, as it increases, the effectiveness of the CO₂ capture by this solvent becomes reduced.

The FIGURE shows a process diagram of the process of the present invention that removes both CO₂ and SOₓ using a potassium carbonate solvent in the Benfield process. In this process, a part of regenerated solvent is withdrawn from the recycle stream. This solvent withdrawn is then cooled down to the temperature when K₂SO₄ will precipitate. After being cooled, the mixture of solid K₂SO₄ and liquid K₂CO₃ is passed through a filter where the solid K₂SO₄ is removed from the system. The liquid solvent is recycled and combined with the recycle of the lean solvent. The concentration of K₂SO₄ in the recycle lean solvent can be controlled by both the flow rate of the stream to be cooled down and the temperature of the stream. This process will avoid the build up of K₂SO₄ in the K₂CO₃ solution, and can be employed to remove both CO₂ and SOₓ from the flue gas.

This process will save significant capital cost in eliminating the requirement for an FGD unit in a power plant. At the same time, since the flue gas does not go through the FGD unit, it will reduce the overall pressure drop of the process. In power plant operation, due to the high flue gas flow rate, any pressure drop will cause significant operating cost. This process will also reduce the compression/operating cost caused by the use of an FGD unit.

The flue gas stream that is cleaned in the process of the present invention is first passed into an absorption zone. Those skilled in the art will recognize that a large number of different types of apparatus may be employed to achieve the required vapor-liquid contacting between the feed gas stream and the absorbent liquid. The exact type of apparatus employed to achieve this contacting does not affect the operation of the process as long as the contacting is performed in a commercially acceptable and efficient manner. The absorption zone may therefore comprise vertical trays in columns, vertical packed columns or various types of mechanical admixing devices including other types of trays or spray nozzles, etc.

In the embodiment shown in the FIGURE, the function of the absorption column 4 is to remove carbon dioxide and sulfur oxides. This may be achieved through judicious design and operation of the absorption zone based on known engineering principles and the absorptive characteristics of the circulating absorptive liquid.

The absorption zone is maintained at absorption-promoting conditions which are chosen based on such factors as the delivery pressure of the feed gas stream and the absorptive characteristics of the circulating carbonate stream. The absorption-promoting conditions will normally comprise a superatmospheric pressure in excess of about 138 kN/m² (20 psia) up to about 3448 kN/m² (500 psia). However, there is no specific upper limit to the pressure which may be employed within the absorption zone and a pressure on the order of 6897 or 13793 kN/m² (1000 or 2000 psia) could be employed if so desired. These relatively high pressures could be desirable when the feed gas stream is being circulated through a process which operates at these pressures. The normal situation is that the feed gas stream will be at a relatively low pressure and the utilities cost of pressurizing the feed gas stream will dictate the operation of the process at a pressure near that of the feed gas stream as it is supplied to the process. The absorption zone may be operated at an ambient temperature in the range of from about 50° to about 120° C., with lower temperatures being desirable as they favor absorption. However, the process is not limited to these temperatures and if the absorptive characteristics of the absorbent liquid permit, the absorption zone may be operated at temperatures up to and including 220° C. Those skilled in the art are cognizant of the fact that the operation of the absorption zone at an elevated temperature may require higher pressures and increased circulation rates of the carbonate solution. The ratio of liquid to gas passing through the absorption zone is set by the absorptive characteristics of the carbonate solution, the operating conditions of temperature and pressure, the concentration of impurities in the flue gas stream, and the degree to which it is desired to remove these compounds from the flue gas stream.

The absorptive liquid which is circulated through the process is an aqueous solution of a carbonate. The carbonate may be chosen from ammonium carbonate, sodium carbonate or potassium carbonate, with potassium carbonate being preferred and primarily discussed herein. It is believed that the subject process is not limited to operation with these three carbonates and any other carbonate which is commercially suitable may be employed. The carbonate solution should contain between about 10 and about 45% by weight carbonate. Particularly preferred is a solution of from about 20 to about 35% by weight potassium carbonate based on potassium being present as potassium carbonate. Potassium carbonate solutions are often “activated” by small amounts of additives such as amines, alkali metal borates, or amino acids. The trialkanol amines or other tertiary amines are highly suitable as such activating agents. Diethanolamine may also be employed if preferred. The amount of the activating agent is preferably from about 0.1 to 10 wt-% of the total carbonate solution and more preferably is less than 5 wt-% of the solution. Monoethanolamine can be employed at higher concentrations up to 25 wt-% of the solution.

The aqueous carbonate solution which is withdrawn from the absorber unit is passed into a stripping column 10 where the carbonate solution is regenerated in a manner similar to that employed in other processes which utilize a carbonate solution for scrubbing carbon dioxide from a gas stream. The carbonate solution will therefore normally be fed into an upper portion of a vertical stripping column containing vapor-liquid contacting trays or a fixed bed of suitable packing material. Preferably, the carbonate solution is substantially reduced in pressure immediately before being passed into the stripping column, with this pressure reduction resulting in the release of carbon dioxide from the carbonate solution. The regeneration of the carbonate solution is normally aided by hot vapors which rise through the stripping column countercurrent to the descending carbonate solution. These vapors may be produced utilizing an indirect heat exchange means (reboiler) located at the bottom of the stripping column in a relatively conventional manner or in somewhat more complicated but also more energy-efficient methods such as those described in U.S. Pat. No. 4,160,810. The pressure maintained within the stripping zone will preferably be substantially lower than that maintained in other portions of the process and will normally range from between about 103 and 345 kN/m² (15 to 50 psia), although higher pressures could possibly be employed. The temperature required within the stripping zone will depend on the pressure maintained within the stripping zone and the absorptive characteristics of the carbonate solution. It is preferred that the temperature within the stripping zone does not exceed 220° C. The stripping zone is normally refluxed with water condensed out of the total overhead vapor stream. Operating at elevated temperatures and pressure allows a more complete condensation of the water to be achieved without the use of extensive refrigeration capacity, and therefore reduces the cooling utilities cost of the stripping operation.

A properly designed and operated stripping zone will produce a net bottoms liquid stream comprising a lean carbonate solution exiting in stream 31. This carbonate solution will be lean in carbon dioxide. As used herein, the term “rich” is intended to indicate that the absorption liquid has passed through an absorption zone and that the indicated chemical compound has been transferred to the absorption liquid from the gas stream being treated. The use of this term is not intended to indicate a preference for either physical or chemical absorption of the compounds removed from the feed gas stream. Normally, the carbon dioxide will become a portion of a bicarbonate. The fact that the absorbed chemical compounds may lose their identity while they are carried through the process by the absorptive liquid is generally recognized in the common usage of these descriptive terms as they are applied to the absorptive liquid. To further define the usage of these terms herein, it may be noted that any carbonate stream circulating through this process which subsequent to its withdrawal from the stripping zone is brought into contact with carbon dioxide at suitable absorption-promoting conditions will be referred to herein as a carbon dioxide-rich carbonate solution.

Referring now to the FIGURE, a feed gas stream which is normally a flue gas comprises an admixture of nitrogen and oxygen from the combustion air, carbon dioxide, nitrogen oxides and sulfur oxides enters absorption column 4 through line 2. The gas stream travels upward through the absorption column countercurrently to a descending stream of potassium carbonate solvent delivered to the absorption column through line 3. A treated gas which is free of carbon dioxide and sulfur oxides, is shown exiting in line 6. After passing through the absorption column, a carbonate solution which is rich in both sulfur oxides and carbon dioxide is removed from absorption column 4 through line 8.

The rich carbonate solution is passed into a stripping zone 10 through line 8. The stripping zone is operated at suitable conditions including an elevated temperature and reduced pressure which result in the release of the carbon dioxide present in the carbonate solution. This effects the production of a carbon dioxide stream which is removed from the process in line 28 and a lean carbonate solution which is withdrawn from the stripping zone through line 31 and recycled to the absorption column. Reflux is generated for the stripping column 10 by the stripped carbon dioxide 24 passing through a heat exchanger 26 with condensed water 30 returned to the column to reenter the stripping zone. A portion of the potassium carbonate solvent stream is removed through line 14 to pass through a heat exchanger or other cooling device 16 and then line 18 to enter filter 20 whereupon potassium sulfate is removed after being precipitated from the solvent. The resulting clean potassium carbonate stream is recycled through line 22 to line 3 to absorption zone 4. A portion of the carbonate solution may be withdrawn through line 32 to be sent through a heat exchanger 34 to be heated and then returned to stripping zone 10 or sent through line 3 to adsorption zone 4.

This description of an embodiment of this invention is not intended to preclude from the scope of the subject invention those other embodiments set out herein or which are the result of the normal and reasonably expected modifications of those embodiments. Those skilled in the art will recognize that the basic process of the subject invention may be varied considerably.

1. A process of simultaneously reducing carbon dioxide (CO₂) and sulfur oxide (SOₓ) emissions from flue gases produced by combustion of carbon-containing matter, said method comprising the steps of:
a) sending said flue gas to an absorber unit to be contacted with a potassium carbonate solution to remove CO₂ and SOₓ to produce a treated gas and a rich stream of potassium carbonate solvent containing said CO₂ and SOₓ and K₂SO₄ produced by reaction of said potassium carbonate solution and said SOx;
b) sending said rich stream to a stripper to remove said CO2 from said rich stream of potassium carbonate solvent and to produce a partially rich solvent stream containing K₂SO₄;
c) removing a portion of said partially rich solvent stream;
d) removing said K₂SO₄ from said partially rich solvent stream by cooling said partially rich solvent stream to a temperature at which said K₂SO₄ will precipitate from said portion of said rich solvent stream to produce a lean solvent stream; and
e) returning said lean solvent stream to said potassium carbonate solution.

2. The process of claim 1 wherein said lean solvent stream comprises less than 2% K₂SO₄.

3. The process of claim 1 wherein said cooled partially rich solvent stream is filtered to remove K₂SO₄.

4. In a process for recovering CO₂ from a flue gas containing CO₂ and SOₓ wherein the flue gas is contacted with a potassium carbonate solution, the CO₂ and SOₓ components absorbed therein to form a rich solvent stream containing KHCO₃ and K₂SO₄, and the CO₂ removed from the said rich solvent stream to produce a partially rich solvent stream, the improvement which comprises:
a) removing a portion of said partially rich solvent stream;
b) removing said K₂SO₄ from said partially rich solvent stream by cooling said partially rich solvent stream to a temperature at which said K₂SO₄ will precipitate from said portion of said partially rich solvent stream to produce a lean solvent stream; and
c) returning said lean solvent stream to said potassium carbonate solution.

5. The process of claim 4 wherein said lean solvent stream comprises less than 2% K₂SO₄.

6. The process of claim 4 wherein said cooled rich solvent stream is filtered to remove K₂SO₄.
